(19) United States
(12) Patent Application Publication
(10) Pub. No.: US 2004/0152428 A1
(43) Pub. Date: Aug. 5, 2004

(54) Method for transmitting a digital message and system for carrying out said method

(76) Inventors: Andrey Alexejevich Plotnikov, Vyborg (RU); Said Kakhsurujevic H Akajev, Vyborg (RU); Victor Fyodorovich Velikokhatsky, St. Petersburg (RU); Vadim Yevgenievich Lysy, Vyborg (RU)

Correspondence Address: Oleg F Kaplun, Fay Kaplun & Marcin, Suite 702, 150 Broadway, New York, NY, 10038, US

(21) Appl. No.: 10/478,885

(22) PCT Filed: Oct. 16, 2001
(86) PCT No.: PCT/RU01/00418

(30) Foreign Application Priority Data
May 22, 2001 (RU) 2001113566

(51) Int. Cl. H04B 1/02

(52) U.S. Cl. 455/91; 455/95

(57) ABSTRACT

The invention relates to telecommunications, in particular to methods and means for transmitting digital messages and can be used for transmitting information through wire channels and telecommunication channels using electromagnetic waves. The use of said channels is simplified by excluding multiplication and division operators from a coding and decoding process. Said invention makes it possible to transmit any messages from elements of Abelian group including code words whose elements are matrixes, polynomials, numbers of mixed-base notation and nonpositional notation. The codes based on the inventive rules pertain to the class of systematic linear block codes. The inventive system for transmitting a digital message comprises an encoder (1), a modulator (2), a transmitter (3), a receiver (4) a demodulator (5) and a decoder (6).

### FIELD OF THE INVENTION

This invention relates to telecommunications, in particular to methods and means for transmitting digital messages, and can be used for transmitting information through wire channels and through telecommunication channels using electromagnetic waves.

### DESCRIPTION OF THE PRIOR ART

A method for transmitting digital message, consisting of additive Abelian group elements, is known. This method comprises consequent steps of: encoding digital message, its modulating and its transmitting in a communication channel and demodulating received signal and its decoding [1].

A known system for transmitting digital messages, consisting of additive Abelian group elements, comprises serially connected at a transmitting side an encoder, a modulator and a transmitter and serially connected at a receiving side a receiver, a demodulator and a decoder [1].

Known method and system are rather complicated in a realization because they require to use four arithmetic operations for procedures of encoding and decoding.

### DISCLOSURE OF THE INVENTION

A technical result, achieved when using proposed method and system, provides simplifying their realization due to excluding multiplication and division operations from procedures of encoding and decoding. This provides, in its turn, an opportunity to transmit any messages, consisting of Abelian group elements, in particular encoded words with elements in a form of matrixes, polynomials, numerals in a mixed and non-positional number system, and in this case codes, organized in accordance with proposed rules, correspond to a class of systematic linear block codes.

An above-mentioned technical result is achieved by producing operations of encoding, in a method for transmitting digital message, consisting of additive Abelian group elements, comprising consequent steps of: encoding digital message, its modulating and its transmitting in a communication channel and demodulating received signal and its decoding, the encoding is carried out in accordance with the following rule: Yₙ=Xₖ\mathring{×}G, where

Xₖ—a vector-row of an initial message, consisting of k information elements,

Yₙ—a vector-row of an encoded message, consisting of k information and m check elements, m—the smallest integer not less, than log₂ n, n=k+m,

G—a generating matrix of operations which consists of k rows and n columns, produced with a help of a k×k matrix, with operations g⁰ at a diagonal and operations g¹ at other positions, and with a help of an additional k×m matrix, which is added to a k×k matrix from the right and non-repeated rows of which are sequences of operations g¹ and g⁰ or operations g¹ and g², chosen from any possible sequences, including not more than (m−2) operations g¹, or a matrix, determined with a help of an above-mentioned generating matrix of operations by rearranging rows and/or columns,

\mathring{×}—an operation of generalized matrix multiplication in accordance with the following rule: yⱼ=^{\mathring{+}}Σg^{v}ᵢⱼ(xᵢ) for j≦k, yⱼ=g²[^{\mathring{+}}Σ g^{v}ᵢⱼ(xᵢ)] for j>k, if rows in an additional matrix corresponds to sequences of operations g¹ and g⁰, or in accordance with the following rule: yⱼ=^{\mathring{+}}Σg^{v}ᵢⱼ(xᵢ), if rows in an additional matrix corresponds to sequences of operations g¹ and g², where

yⱼ—a j-th element of a vector-row for an encoded message,

^{\mathring{+}}Σ g^{v}ᵢⱼ(xᵢ)=g^{v}ₗⱼ(x₁)\mathring{+}g^{v}₂ⱼ(x₂)\mathring{+} . . . \mathring{+}g^{v}ₖⱼ(xₖ),

\mathring{+}—an operation for summing elements in an Abelian group,

g^{v}ᵢⱼ(xᵢ)—an operation g^{v} for an element xᵢ in accordance with a rule for a ij-th matrix element,

v=[0,2], i=[1, k], j=[1, n],

g⁰=xᵢ\mathring{+}e, g¹=xᵢ\mathring{+}(−xᵢ), g²=xᵢ\mathring{+}(−xᵢ)\mathring{+}(−xᵢ),

e—a unity element of an Abelian group,

and producing operations of decoding message Y′ₙ by excluding from a vector-row Y′ₙ elements, corresponding by their numbers, to columns of a check matrix of operations H with one operation g⁰, provided there is not more than one element, not equal e, in vector-column S^{T}ₘ, organized in accordance with the following rule: S_{T}ₘ=H\mathring{×}Y′ₙ^{T}, where

Y′ₙ^{T}—a transposed vector-row Y′ₙ,

H—a m×n check matrix of operations, produced by an additional matrix transposition, adding m×m matrix with operations g⁰ at its diagonal and operations g¹ at other positions to this matrix from the right and rearranging columns (identically to rearranging columns of an generating matrix of operations), if rows of an additional matrix correspond to sequences of operations g¹ and g⁰, or in the same way with changing operations g² for operations g⁰, if rows in an additional matrix correspond to sequences of operations g¹ and g².

An above-mentioned technical result is achieved, also, by changing, before excluding from vector-row Y′ₙ elements, corresponding, by their numbers, to columns of a check matrix of operations H, in a situation when vector-column S^{T}ₘ contains identical elements, not equal e, and when vector-column S^{T}ₘ, conversed by changing its above-mentioned elements for an operation g⁰ and its other elements—for an operation g¹, corresponds to a j-th column of a matrix H, value for a j-th symbol of a vector-row Y′ₙ by adding it to an element, inverse to one of the elements, not equal e, in vector-column S^{T}ₘ.

An above-mentioned technical result is achieved, also, by providing correspondence, in a situation when message elements belong to a ring with a unity, of an operation g⁰ to an operation of a multiplication into a unity, of an operation g¹ to an operation of a multiplication into a zero and of an operation g² to an operation of a multiplication to a minus unity.

An above-mentioned technical result is achieved, also, by providing a correspondence, in a situation when message elements belong to a residue class ring to the modulo q, where q is a natural number, of an operation \mathring{+} to an operation of summing to the modulo q.

An above-mentioned technical result is achieved, also, by using, in a system for transmitting digital message, consisting of an additive Abelian group elements, comprising serially connected at a transmitting side an encoder with an input corresponding to a system input, a modulator and a transmitter and serially connected at a receiving side a receiver, a demodulator and a decoder with an output corresponding to a system output for a non-correctable message, an encoder in a form, permitting to realize the following algorithm Yₙ=Xₖ\mathring{×}G, where

Xₖ—a vector-row of an initial message, consisting of k information elements,

Yₙ—a vector-row of an encoded message, consisting of k information and m check elements, m—the smallest integer not less, than log₂ n, n=k+m,

G—a generating matrix of operations which consists of k rows and n columns, produced with a help of a k×k matrix, with operations g⁰ at a diagonal and operations g¹ at other positions, and with a help of an additional k×m matrix, which is added to a k×k matrix from the right and non-repeated rows of which are sequences of operations g¹ and g⁰ or operations g¹ and g², chosen from any possible sequences, including not more than (m−2) operations g¹, or a matrix, determined with a help of an above-mentioned operating matrix of operations by rearranging rows and/or columns,

\mathring{×}—an operation of generalized matrix multiplication in accordance with the following rule: yⱼ=^{\mathring{+}}Σg^{v}ᵢⱼ(xᵢ) for j≦k, yⱼ=g²[^{\mathring{+}}Σ g^{v}ᵢⱼ(xᵢ)] for j>k, if rows in an additional matrix correspond to sequences of operations g¹ and g⁰, or in accordance with the following rule: yⱼ=^{\mathring{+}}Σg^{v}ᵢⱼ(xᵢ), if rows in an additional matrix correspond to sequences of operations g¹ and g², where

yⱼ—a j-th element of a vector-row for an encoded message,

^{\mathring{+}}Σ g^{v}ᵢⱼ(xᵢ)=g^{v}₁ⱼ(x₁)\mathring{+}g^{v}₂ⱼ(x₂)\mathring{+} . . . \mathring{+}g^{v}ₖⱼ(xₖ),

\mathring{×}—an operation for summing elements in an Abelian group,

g^{v}ᵢⱼ(xᵢ)—an operation g^{v} for an element xᵢ in accordance with a rule for a ij-th matrix element,

v=[0, 2], i=[1, k], j=[1, n],

g⁰=xᵢ\mathring{+}e, g¹=xᵢ\mathring{+}(−xᵢ), g²=xᵢ\mathring{+}(−xᵢ)\mathring{+}(−xᵢ),

e—a unity element of an Abelian group,

and by using a decoder in a form, permitting to exclude from a vector-row Y′ₙ elements, corresponding by their numbers to columns of a check matrix of operations H with one operation g⁰, provided there is not more than one element, not equal e, in a vector-column S^{T}ₘ, organized in accordance with the following rule: S^{T}ₘ=H\mathring{×}Y′ₙ^{T}, where

Y′ₙ^{T}—a transposed vector-row Y′ₙ,

H—a m×n check matrix of operations produced by an additional matrix transposition, adding mxm matrix with operations g⁰ at its diagonal and operations g¹ at other positions to this matrix from the right and rearranging columns, identically to rearranging columns of an generating matrix of operations, if rows of an additional matrix correspond to sequences of operations g¹ and g⁰, or in the same way with changing operations g² for operations g⁰, if rows in an additional matrix correspond to sequences of operations g¹ and g².

An above-mentioned technical result is achieved, also, by providing a decoder, permitting to change before excluding from vector-row Y′ₙ elements, corresponding by their numbers to columns of a check matrix of operations H, a value of a j-th symbol in a vector-column by adding it to an element, inverse to one of the elements, not equal e, in a vector-column S^{T}ₘ, in a situation when a vector-column S^{T}ₘ contains identical elements, not equal e, and when a vector-column S^{T}ₘ, conversed by changing its said elements for an operation g⁰ and its other elements—for an operation g¹, corresponds to a j-th column of a check matrix of operations H.

An above-mentioned technical result is achieved, also, by providing encoder with the first operative memory unit with k outputs connected to corresponding first k information inputs of the second operative memory unit, an output of which forms an encoder output, the memory unit, used for storing operation codes of an generating matrix of operations, the first group of m calculation units, used for determining check element, with calculation algorithm control inputs connected to m corresponding outputs of the memory unit, used for storing operation codes of an generating matrix of operations, m calculation units for calculating function g², connected between corresponding outputs of the first group of m calculation units, used for determining check element, and corresponding information inputs, from (k+1)-th to n-th, of the second operative memory unit, serially connected the first pulse shape forming unit and the first ring counter, used for counting up to k, with an information input connected to a matrix row address input of the memory unit, used for storing operation codes of an generating matrix of operations, and with an overflow output connected to reset inputs of the first operative memory unit and the first group of m calculation units, used for determining check element, serially connected the pulse generator with a repetition frequency of fn/k, the first switch and the first ring counter, used for counting up to n, with an information output connected to an address input of the second operative memory unit, the first gate AND with an output connected to a control input of the first switch, the first flip-flop with an output connected to a direct input of the first gate AND, an inverting input of which is connected with an overflow output of the first ring counter, used for counting up to n, and to a reset input of the first flip-flop, serially connected the first pulse repetition frequency doubling unit with an input connected to an output of the pulse generator, having a repetition frequency of fn/k, and the ring counter, used for counting up to (2k+1), with an overflow output connected to a counting input of the first flip-flop, combined inputs of the first operative memory unit and of calculation units, used for determining check element, of the first group, consisting of m such calculation units, a start input of the pulse shape forming unit and a synchronization input of the pulse generator with a repetition frequency of fn/k form an encoder input and f corresponds to a repetition frequency for a digital message elements.

An above-mentioned technical result is achieved, also, by providing a decoder with the third operative memory unit with n outputs connected to m corresponding information inputs of the fourth operative memory unit, an output of which forms a decoder output for a non-correctable message, the memory unit, used to storing operation codes of an generating matrix of operations, the second group of m calculation units, used for determining check element, with calculation algorithm control inputs connected to m corresponding outputs of the memory unit, used for storing operation codes of an generating matrix of operations, serially connected the second pulse shape forming unit and the second ring counter, used for counting up to n, with an information input connected to an address input of the memory unit, used for storing operation codes of an generating matrix of operations, and with an overflow output connected to reset inputs of the third operative memory unit and calculation units, used for determining check element, of the second group consisting of m such calculation units, serially connected the pulse generator with a repetition frequency of fk/n, the second switch, the second ring counter, used for counting up to k, and the third switch with an information output connected to an address input of the fourth operative memory unit, the unit for making decisions on decoding with m inputs connected to outputs of corresponding calculation units, used for determining check element and belonged to the second group consisting m of such calculation units, and with its output connected to a control input of the third switch, the second gate AND with an output connected to a control input of the second switch, the second flip-flop with an output connected to a direct input of the second gate AND, an inverting input of which is connected to an overflow output of the second ring counter, used for counting up to k, and to a reset input of the second flip-flop, serially connected the second pulse repetition frequency doubling unit with an input connected to an output of the pulse generator with a repetition frequency of fk/n, and the ring counter, used for counting up to [(2(k+1)+1], with an overflow output connected to a counting input of the second flip-flop, combined inputs of the third operative memory unit and calculation units, used for determining check element, of the second group, consisting of m such calculation units, a start input of the second pulse shape forming unit and a synchronization input of the pulse generator with a repetition frequency of fk/n form a decoder input.

An above-mentioned technical result is achieved, also, by connecting an output of the unit for making decisions on decoding to a control input of the third switch through the first gate OR and by providing unit for making decisions on correcting errors with an output connected to a second input of the first gate OR, serially connected error calculation unit with a start input connected to an output of the unit for making decisions on correcting errors and with a writing input connected to an overflow output of the second ring counter, used for counting up to k, the calculation unit for calculating function g² and the adder for summing Abelian group elements with a second input connected to an output of the fourth operative memory unit and with an output, used as output of a decoder output for a correctable message, m inputs of the unit for making decisions on correcting errors and m inputs of the calculation unit for calculating error are connected to outputs of corresponding calculation units, used for determining check element, of the second group, consisting of m such calculation units.

An above-mentioned technical result is achieved, also, by providing the calculation unit, used for determining check element, with serially connected the fourth switch, the calculation unit for calculating function g¹, the second gate OR, the accumulating adder, used for accumulating Abelian group elements, with an output connected to its second input and the fifth switch with a control input in a form of a reset input and with an output in a form of an output for the calculation unit, used for determining check element, the sixth switch with an output connected to a second input of the first gate OR, the decipher with an input in a form of a calculation algorithm control input for the calculation unit, used for determining check element, and with outputs connected, correspondingly, to control inputs of the sixth and fourth switches, combined information inputs of which form an information input of the calculation unit, used for determining check element.

### BRIEF DESCRIPTION OF THE FIGURES

FIG. 1 illustrates an example of individual message coding and decoding;

FIG. 2 illustrates an electrical block scheme of a system for transmitting digital message;

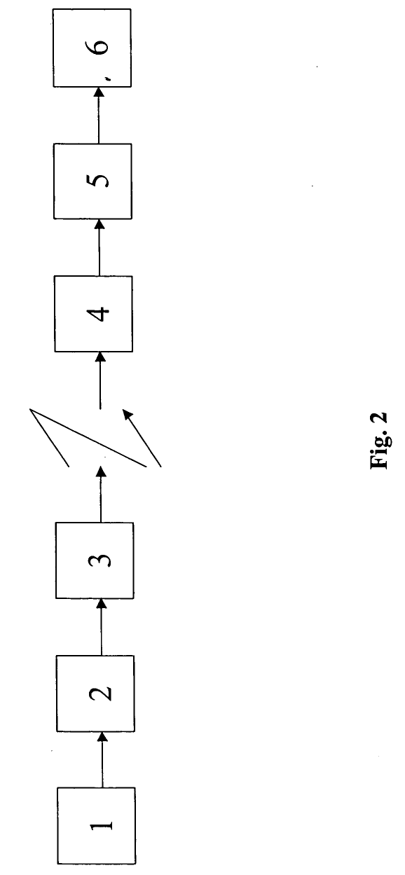

FIG. 3 illustrates an electrical block scheme of an encoder;

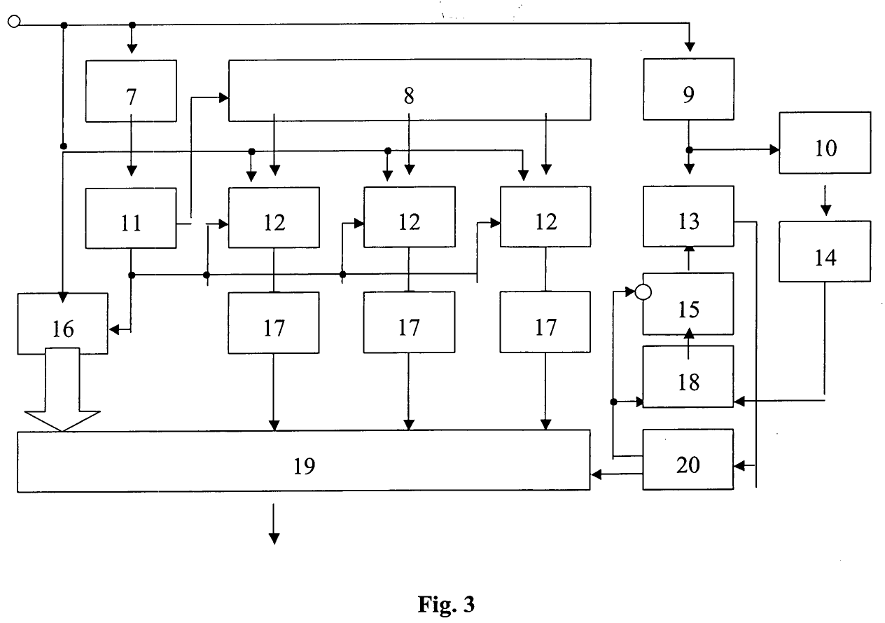

FIG. 4 illustrates an electrical block scheme of a decoder; and

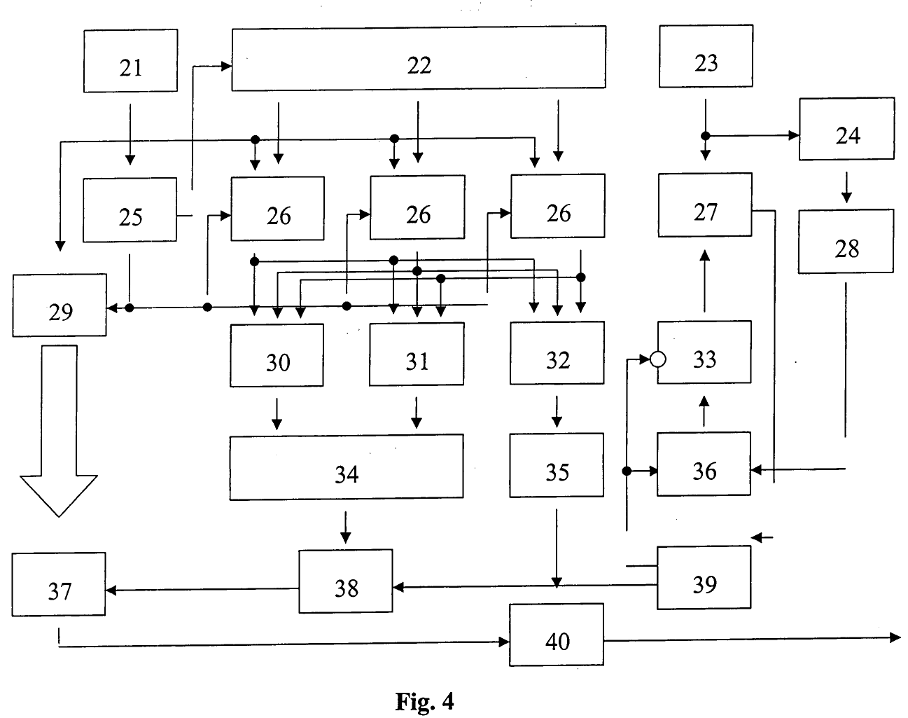

FIG. 5 illustrates an electrical block scheme of a calculation unit, used for determining check element.

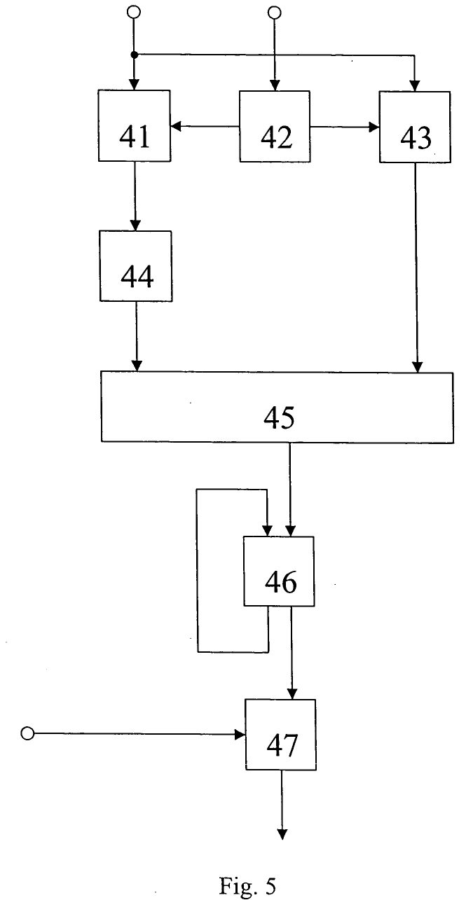

A system for transmitting digital message consists of an encoder 1, a modulator 2, a transmitter 3, a receiver 4, a demodulator 5 and a decoder 6.

An encoder 1 consists of the first pulse shape forming unit 7, the memory unit 8, used for storing operation codes of an additional operation matrix, the pulse generator 9 with a repetition frequency of fn/k, the first pulse repetition frequency doubling unit 10, the first ring counter 11, used for counting up to k, the first group of m calculation units, 12, used for determining check element, the first switch 13, the ring counter 14, used for counting up to (2k+1), the first gate AND 15, the first operative memory unit 16, m calculation units, 17, used for calculating function g², the first flip-flop 18, the second operative memory unit 19 and the first ring counter 20, used for counting up to n.

A decoder 6 consists of the second pulse shape forming unit 21, the memory unit 22, used for storing operation codes of a check matrix of operations, the pulse generator 23 with a repetition frequency of fk/(k+1), the second pulse repetition frequency doubling unit 24, the second ring counter 25, used for counting up to n, the second group of m calculation units, 26, used for determining check element, the second switch 27, the ring counter 28, used for counting up to [2(k+1)+1], the third operative memory unit 29, the unit 30 for making decisions on decoding, the unit 31 for making decisions on correcting error, the error calculation unit 32, the second gate AND 33, the first gate OR, the (m+1)-th calculation unit 35, used for calculating function g², the second flip-flop 36, the fourth operative memory unit 37, the third switch 38, the second ring counter 39, used for counting up to k, and the adder 40, used for summing Abelian group elements.

The calculation unit 12 (26) consists of the fourth switch 41, the decipher 42, the sixth switch 43, the calculation unit 44, used for calculating function g², the second gate OR 45, the accumulating adder 46, used for accumulating Abelian group elements, and the fifth switch 47.

### DESCRIPTION OF THE PREFERABLE EMBODIMENT

A method for transmitting digital message is realized as the following.

An generating matrix of operations with k rows and n columns is formed, said matrix is produced using a k×k matrix with operations g⁰ at its diagonal and operations g¹ at other positions and with a k×m additional matrix, which is added from the right to a k×k matrix and non-repeated rows of which are formed as sequences of operations g¹ and g⁰ or operations g¹ and g², chosen from any possible sequences, including not more than (m−2) operations g¹. It's possible, also, to use an generating matrix of operations, produced with a help of said generating matrix of operations by rearranging its rows and/or columns. The resulting generating matrix of operations is a matrix, formed not of numbers, as usual matrixes, but of records, recommending to produce a corresponding operation in situations, when a corresponding element of an generating matrix of operations is initiated.

An operation of adding additional operation matrix is produced with a purpose to introduce, into a transmitted message, check elements which are used for finding out errors in a received message, if they appear during a message transmission through a communication channel, and for their correcting if there is any opportunity to do this.

A digital message Xₖ is encoded by producing matrix multiplication of a vector-row Xₖ into an above-mentioned generating matrix of operations G.

A procedure of a generalized matrix multiplication operation is quite the same with a procedure of a usual matrix multiplication because it's produced in the same way, as the following: paired interaction operations are produced for a i-th element of a vector-row Xₖ and every ij-th element (which is situated at a crossing of a i-th row and a j-th column) of an operation matrix G and than results of i-th operations are summed with forming a j-th element of a vector-row Yₙ. As a result, every above-mentioned operation, which is required for producing a generalized matrix multiplication operation, can be interpreted as a summing operation in accordance with rules, formulated for elements of an Abelian group [2, p. 140], to which contains elements of a digital message Xₖ (with k information elements), formed with a corresponding source. Operations gᵥ (g⁰, g¹ and g²) corresponds to summing operations with a unity element of a group [2, p. 139], to summing operations with an inverse element of a group [2, p. 140] and to two-fold summing operations with an inverse element of a group, correspondingly.

An encoded message is modulated and transmitted to a communication channel.

A received message is demodulated and decoded by producing operations of a generalized matrix multiplication of a check matrix H into a transposed vector-row V′ₙ^{T}.

A m×n check matrix of operations H is formed by transposing additional matrix, by adding, to it from the right, a mxm matrix with operations g⁰ at its diagonal and operations g¹ at its other positions, if additional matrix rows correspond to sequences of operations g¹ and g⁰, or in the same way with changing operations g² for g⁰, if additional matrix rows correspond to sequences of operations g¹ and g², and by rearranging columns (if an generating matrix of operations formation was done by rearranging columns) in the same way with rearranging columns for an generating matrix of operations.

After analyzing vector-column S^{T}ₘ, formed as a result of producing operations of decoding, a decision is made on an error absence and, if there is not more then one element, not equal a unity element of a group, in a vector-column S^{T}ₘ, elements, corresponding, by their numbers, to check matrix columns, containing one operation g⁰, are excluded from a vector-row Y′ₙ; so, check elements, inserted into a message during a coding procedure, can be discarded.

If vector-column S^{T}ₘ demonstrates a presence of different elements, no one of which equal a unity element of a group, it means that there is an error in a received message and it's necessary to correct this error. For this purpose unity elements in a vector-column S^{T}ₙ are changed for operations g¹ and other elements are changed for operations g⁰. Than a changed vector-column S^{T}ₘ is compared with matrix H columns, a number of its column, corresponding to a vector-column S^{T}ₘ, is determined and a conclusion about an error presence in a symbol of a vector-row Y′ₙ with a number, coinciding with a number of a matrix H column, corresponding to a vector-column S^{T}ₘ, is made. An error correction is done by adding an error symbol of a vector-row Y′ₙ to an element, inverse to any of elements, not equal a unity element of a group, of a vector-column S^{T}ₘ (because in this case all elements of a vector-row S^{T}ₘ, not equal a unity element of a group, are identical).

If message elements belong to a ring with a unity, which corresponds to one of the variants for an additive Abelian group, operations g⁰ degenerate into operations with a multiplication into a unity, operations g¹ degenerate into operations with a multiplication into a zero and operations g² degenerate into operations with a multiplication into a minus unity.

If message elements belong to a residue class ring on the modulo q, which corresponds to one of the variants for a ring with a unity, an operation ^{\mathring{+}}Σ is transformed into an operation of summing on the modulo q.

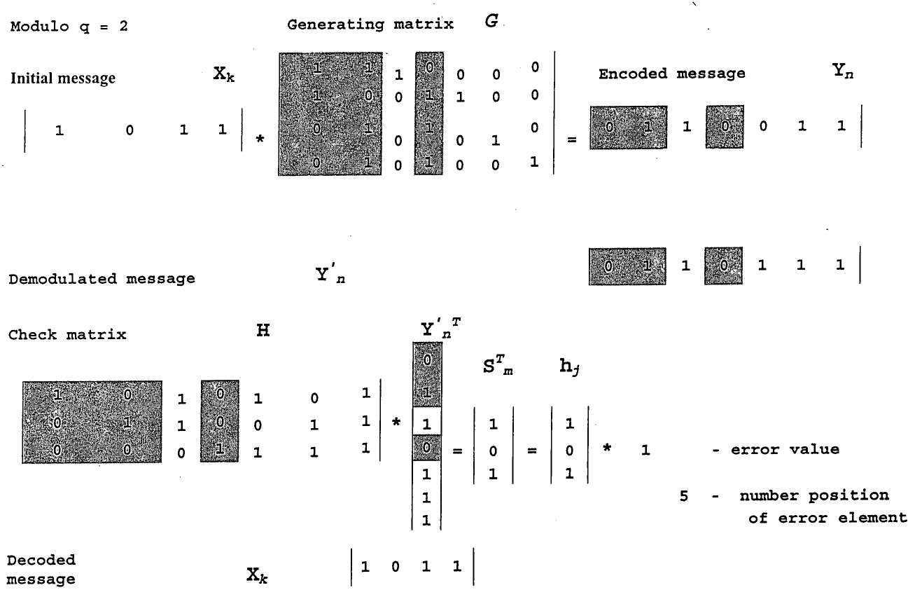

FIG. 1 illustrates an example of transmitting message Xₖ, consisting of four digits. An generating matrix of operations G is formed in accordance with the above-mentioned rule. In this case check columns are situated in first, second and fourth positions. After producing generalized matrix multiplication of a vector-row Xₖ into a matrix G an encoded message vector-row Yₙ, consisting of check symbols, situated in first, second and fourth positions, is formed.

A demodulated message Y′ₙ, is received with an error in the fifth position. So, producing generalized matrix multiplication of a check matrix H into a transposed vector-row Y′ₙ results in getting vector-column S^{T}ₘ, corresponding to the fifth column of a check matrix H. Than decoding is done by discarding check elements, in particular by extracting elements of an initial message and changing the fifth element as a result of its adding to an element, inverse to one of non-unity elements in a vector-column S^{T}ₘ.

A system for transmitting digital message is operated in the following way.

Every element of a digital message Xₖ, formed with a corresponding source and consisting of consequently transmitted code words with a size of k elements each, gets at an input of an encoder 1 and at information inputs of the first operative memory unit 16 and of the first group of calculation units, 12. This element starts the first pulse shape forming unit 7 and synchronizes the pulse generator 9. A pulse from an output of the first pulse shape forming unit 7 starts the first ring counter 11. The first counter 11 provides counting for pulses, coming at its input, and elements of a code word are stored in corresponding cells of the first operative memory unit 16. Every pulse, counted with the counter 11, transfers an operation code set, corresponding to a row of an additional matrix, from an output of the memory unit 8 to calculation algorithm control inputs of the first group of calculation units, 12. These codes get, for every calculation unit 12, to inputs of the decipher 42. In dependence on a type of an operation code, received in the decipher 42, this code opens the fourth switch and helps to transfer an element of a code word to an output of the accumulating adder 46, where this element is conversed in accordance with a rule g² and transferred to a first input of the second gate OR, or the sixth switch with transferring code word element to a second input of the second gate OR and further to an input of the accumulating adder 46. In the accumulating adder 46 every next element is summarized with a sum of previous elements, in accordance with a rule for summing Abelian group elements, and forms a check element. After transferring a k-th element of a code word to an input of the first ring counter 11 a pulse is formed at its overflow output and this pulse resets the first operative memory unit 16 and transfers an information from outputs of the first operative memory unit 16 to first k memory cells of the second operative memory unit 19. At the same time this pulse, after getting at reset inputs of the first group, consisting of m calculation units, 12, opens, for each of these units, the fifth switch 47 and helps to transfer previously formed sums to calculation units, 17, where these values of check elements are conversed in accordance with a rule g² and written into memory cells, from (k+1)-th to n-th, of the second operative memory unit 19. Pulses from an output of the generator 9 with a repetition frequency value, exceeding (k+1)/k times a repetition frequency value for elements in a code word, get at an information input of the second switch 13, which, being kept initially in a closed state, doesn't transfer them to an input of the first ring counter 20. The same pulses are transferred to an input of the first frequency doubling unit 10 which doubles a repetition frequency for coming pulses. Then pulses are transferred from an output of the unit 10 to an input of the ring counter 14. When a (2k+1)-th pulse is transferred (approximately in a middle of a time interval between a moment, when the last element of a current code word comes to an input of an encoder 1, and a moment, when the first element of a next code word comes to this input) to an input of the ring counter 14, a pulse is formed at an overflow output of the counter 14 and transferred to a counting input of the first flip-flop 18, changing a state of this flip-flop. A voltage signal of a “logical unity”, formed at an output of the first flip-flop 18, is transferred to a direct input of the first gate AND 15. The first ring counter 20 hasn't begun to count, yet, and a voltage signal of a “logical zero” is kept at its overflow output: so, a voltage signal of a “logical unity” appears at an output of the first gate AND 15 and this signal helps to open the second switch 13. Pulses from an output of the generator 9 begins to come to an input of the first ring counter 20; as a result, a code appears at an information output of the counter 20 and this code is changed with every next counted pulse. This code, after getting at an address input of the second operative memory unit 19, initializes an information reset in its corresponding memory cell, using the same sequential number with a pulse, counted with the first ring counter 20, and k information and m check elements of a code word are transferred sequentially to an input of a modulator 2. After transferring a n-th pulse to an input of the first ring counter 20 a voltage signal of a “logical unity” is formed at its overflow output and this voltage signal changes a state of the first flip 18; so, a voltage signal of a “logical zero” appears at an output of the first gate AND 15 and this voltage signal closes the first switch 13 and stops getting pulses from an output of the generator 9 to an input of the second ring counter 20, which gets prepared for a next operation cycle.

A modulated message is transferred from an output of a modulator 2 to an input of a transmitter 3 and further to a communication channel.

A received message, after being transferred through a receiver 4, gets demodulated in a demodulator 5 and is transferred to an input of a decoder 6.

Every element in a received code word gets, after being transferred to an input of a decoder 6, at information inputs of the third operative memory unit 29 and of the second group of calculation units, 26, starts the second pulse shape forming unit 21 and synchronizes the generator 23. A pulse from an output of the second pulse shape forming unit 21 starts the second ring counter 25. When the second ring counter 25 counts pulses coming to its input, elements of a code word are stored in corresponding cells of the third operative memory unit 29. Every pulse, counted with the counter 25, transfers an operation code set for a corresponding column of a check operation matrix from the memory unit 22 to calculation algorithm control inputs of the second group of calculation units, 26. These codes are conversed in each calculation unit 26 in the same manner as in a case of using calculation units 12. After transferring a n-th element of a code word to an input of the second ring counter 25 a pulse is formed at its overflow output and this pulse resets the third operative memory unit 29, transfers an information from its outputs to memory cells of the fourth operative memory unit 37 and from outputs of the second group of calculation units, 26, to inputs of the unit 30 for making decisions, of unit 31 for making decisions and of the calculation unit 32. If there is an error in a received message, a command is transferred from an output of the unit 30 for making decisions to a control input of the third switch 38 and this switch gets opened. Pulses from an output of the generator 23 with a repetition frequency, value of which is exceeded k/n times with a value of a repetition frequency for elements in a code word, get to an information input of the second switch 27, which, being kept initially in a closed state, doesn't transfer these pulses to an input of the second ring counter 39. The same pulses are transferred to an input of the second frequency doubling unit 24, which doubles a repetition frequency for coming pulses; pulses from an output of the unit 24 are transferred to an input of the second ring counter 28. When a [2(k+1)+1]-th pulse gets (approximately in a middle of a time interval between a moment, when the last element of a current code word comes to an input of a decoder 6, and a moment, when the first element of a next code word comes to this input) at an input of the ring counter 28, a pulse from an overflow output of the counter 28 is transferred to a counting input of the second flip-flop 36 and changes a state of this flip-flop. A voltage signal of a “logical unity” appears at an output of the second flip-flop 36 and this voltage signal is transferred to a direct input of the second gate AND 33. The second ring counter 39 hasn't begun to count, yet, and a voltage signal of a “logical zero” is kept at its overflow output; so, a voltage signal of a “logical unity” appears at an output of the second gate AND 33 and opens the second switch 27. Pulses from an output of the generator 23 begins to come to an input of the second ring counter 39; as a result, a code appears at an information input of this counter and this code will be changed with every next counted pulse. This code is transferred through the just opened third switch 38 and, after getting at address input of the fourth operative memory unit 37, initializes an information reset it its cell with a sequential number, corresponding to a number of a pulse, counted with the second ring counter 39, and k information elements of a code word are transferred sequentially to a decoder output for a non-correctable error. Check elements are kept, as discarded, in memory cells of the fourth operative memory unit 37 and are changed in these cells for check elements of a next code word. After transferring a k-th pulse to an input of the second ring counter 39 a voltage signal of a “logical unity” appears at its overflow output and this voltage signal changes a state of the first flip-flop 36; then a voltage signal of a “logical zero” is formed at an output of the second gate AND 33 and this voltage signal closes the second switch 27 and stops getting pulses from an output of the generator 23 to an input of the second ring counter 39, which gets prepared for a next operation cycle.

If there is an error in a received message, a command is transferred from an output of the unit 32 for making decisions to a control input of the third switch 38 and this command helps to open the switch 38 and to start the calculation unit 32. The calculation unit 32 determines an error value and its sequential number in a received message and, after transferring pulse to its synchronization input from an information output of the ring counter 39, transfers an error signal to an input of the calculation unit 35. In the calculation unit 35 an error signal is conversed in accordance with a rule g² and is summarized, in the adder 40, with a corresponding element of a received message, being transferred from an output of the fourth memory unit 37, in accordance with a rule for summing elements of an Abelian group; this operations permit to correct an error and to transfer a corrected message to a decoder output for correctable messages.

The unit 30 for making decisions, the unit 31 for making decisions and the calculation unit 32 can be realized in a form of corresponding programs, written in an algorithmic language, for example QBASIC, and run with a help of a typical microprocessor.

A program for a realization of the unit 30 for making decisions.

Values for m elements of a syndrome s at outputs of the second group, consisting of m calculation units, 26, are transferred to a memory area with a name DATA:

DATA s1, s2 . . . sm.

Initial states for memory cells:

erdecod$=“decoding”

msg$=“”

e=0 “a value code for a unity element”

none=e “an initial value for a non-unity element”

countnone=0 “a counter for counting non-unity elements”

m=3; k=4; n=k+m “parameters for a check matrix”

pozer=n+1 “an initial value for an error position pointer”.

Organizing area in an operative memory for a data set s:

DIM s(m).

Organizing area in an operative memory for a data set of a check matrix h$:

DIM h$(m,n).

Values for elements of a check matrix are stored in a memory area DATA:

DATA +e,+e,+e,−x+e,+e,+e,−x+e,+e,+e,−x

DATA +e,−x,−x,−x,+e,−x,−x,−x,+e.

Loading m values for syndrome elements into an operative memory:

FOR I=1 TO m: READ s(i): NEXT i.

Loading check matrix into an operative memory:

FOR j=1 TO n: FOR i=1 TO m: READ h$(i,j): NEXT i: NEXT j.

Counting quantity of non-unity elements in a syndrome and, if their quantity equals a zero, making decision on decoding received message:

c=0: FOR i=TO m: IF s(i) <> e THEN c=c+1 NEXT i: countnone=c

IF countnone=0 THEN msg$=erdecod$

END.

A program for a realization of the unit 31 for making decisions.

Values for m elements of a syndrome s at outputs of the second group, consisting of m calculation units, 26, are transferred to a memory area DATA, which contains a value for a number m:

DATA s1, s2 . . . sm.

Initial states for memory cells:

erdecod$=“decoding”

msg$=“”

e=0 “a value code for a unity element”

none=e “an initial value for a non-unity element”

countnone=0 “a counter for counting non-unity elements”

m=3; k=4; n=k+m “parameters of a check matrix”

pozer=n+1 “an initial value for an error position pointer”.

Organizing area in an operative memory for a data set s:

DIM s(m).

Organizing area in an operative memory for a data set of a check matrix h$:

DIM h$(m,n).

Values for elements of a check matrix are stored in a memory area DATA:

DATA +e,+e,+e,−x,+e,+e,+e,−x,+e,+e,+e,−x

DATA +e,−x,−x,−x,+e,−x,−x,−x,+e,−x,−x,−x,+e.

Loading m values of syndrome elements into an operative memory:

FOR i=1 TO m: READ s(i): NEXT i.

Loading check matrix into an operative memory:

FORj=1 TO n: FOR i=1 TO m: READ h$(i,j): NEXT i: NEXT j.

Counting quantity of non-unity elements in a syndrome and, if their quantity equals a zero, making decision on decoding a received message:

c=0: FOR i=1 TO m: IF s(i) <> e THEN c=c+1 NEXT i: countnone=c

IF countnone=1 THEN msg$=erdecod$

END.

A program for a realization of the calculation unit 32.

Values of m elements in a syndrome at outputs of the second group, consisting of m calculation units, 26, are transferred into a memory area with a name DATA:

DATA s1, s2 . . . sm.

Initial states for memory cells:

erdecod$=“decoding”

mgs$=“”

c=0 “a value code for a unity element”

none=e “an initial value for a non-unity element”

countnone=0 “a counter for counting non-unity elements”

m=3; k=4; n=k+m “parameters of a check matrix”

pozer=n+1 “an initial value for an error position pointer”.

Organizing area in an operative memory for a data set s:

DIM s(m).

Organizing area in an operative memory for a data set of a check matrix h$:

DIM h$(m,n).

Values for elements of a check matrix are stored in a memory area DATA:

DATA +e,+e,+e,−x,+e,+e,+e,−x,+e,+e,+e,−x

DATA +e,−x,−x,−x,+e,−x,−x,−x,+e.

Loading m values of a syndrome elements into an operative memory:

FOR i=1 TO m: READ s(i): NEXT i.

Loading check matrix into an operative memory:

FOR j=1 TO n: FOR i=1 TO m: READ h$(I,j): NEXT i: NEXT j.

Calculating first non-unity element in a syndrome:

FOR i=1 TO m

IF s(i)=e THEN GOTO nxi:

none=s(i).

A check of other non-unity elements for their correspondence to the first element and, in a case of their correspondence, a calculation of an error and a number for its position in a received message:

FOR j=i+1 TO m

IF so)=e THEN GOTO nxj

IF so)=none THEN GOTO nxj

GOTO mout1

nxj: NEXT j

nxi: NEXT i.

A calculation of a parameter pozer—a number for an error position in a received message:

FOR j=1 TO k

pozer=j

FORi=1 TO m

IF s(i)=none AND h$(i,j)=“+e” OR s(i)=e AND h$(i,j)=“−x”0 THEN p=1

ELSE p=0

ENF IF

IF p=0 THEN GOTO nj

NEXT i

IF p=1 THEN GOTO mout1

nj: NEXT j.

Storing error value into a memory cell with a name none and its number in a received message into a memory cell with a name pozer:

mout1:

END.

Literature

1. J. Clark, J. Cane. Coding with an error correction in digital communication systems, translated from English by S. I. Gelfand, Under edition of B. S. Tsybakov, Issue 28, Moscow, Publisher “Radio i svyaz”, 1987. p.p. 9-18, FIG. 1.2.

2. A. I. Kostrikin, Introduction for an algebra, Moscow, Publisher “Nauka”, 1977.

1. A method for transmitting digital message, consisting of additive Abelian group elements that comprises consequent steps of: encoding digital message, its modulating and its transmitting in a communication channel and demodulating received signal and its decoding, differs in that the encoding is carried out in accordance with the following rule producing operation of coding message in accordance with a rule: Yₙ=Xₖ\mathring{×}G, where
Xₖ—a vector-row of an initial message, consisting of k information elements,
Yₙ—a vector-row of an encoded message, consisting of k information and m check elements, m—the smallest integer not less, than log₂ n, n=k+m,
G—a generating matrix of operations which consists of k rows and n columns, produced with a help of a k×k matrix, with operations g⁰ at a diagonal and operations g¹ at other positions, and with a help of an additional k×m matrix, which is added to a k×k matrix from the right and non-repeated rows of which are sequences of operations g¹ and g₀ or operations g¹ and g², chosen from any possible sequences, including not more than (m-2) operations g₁, or a matrix, determined with a help of an above-mentioned generating matrix of operations by rearranging rows and/or columns,
\mathring{×}—an operation of generalized matrix multiplication in accordance with the following rule: yⱼ=^{\mathring{+}}Σg^{v}ᵢⱼ(xᵢ) for j≦k, yⱼ=g²[^{\mathring{+}}Σ g^{v}ᵢⱼ(xᵢ)] for j>k, if rows in an additional matrix corresponds to sequences of operations g¹ and g⁰, or in accordance with the following rule: yⱼ=^{\mathring{+}}Σg^{v}ᵢⱼ(xᵢ), if rows in an additional matrix corresponds to sequences of operations g¹ and g², where
yⱼ—a j-th element of a vector-row for an encoded message,
^{\mathring{+}}Σ g^{v}ᵢⱼ(xᵢ)=g^{v}₁ⱼ(xᵢ)\mathring{+}g^{v}₂ⱼ(x₂)\mathring{+} . . . \mathring{+}g^{v}ₖⱼ(xₖ),
\mathring{+}—an operation for summing elements in an Abelian group,
g^{v}ᵢⱼ(xᵢ)—an operation g^{v} for an element xᵢ in accordance with a rule for a ij-th matrix element,
v=[0, 2], i=[1, k], j=[1, n],
g⁰=xᵢ\mathring{+}e, g¹=xᵢ\mathring{+}(−xᵢ), g²=xᵢ\mathring{+}(−xᵢ)\mathring{+}(−xᵢ),
e−a unity element of an Abelian group,
and in decoding message Y′ₙ by excluding from a vector-row Y′ₙ elements, corresponding by their numbers, to columns of a check matrix of operations H with one operation g⁰, provided there is not more than one element, not equal e, in vector-column S^{T}ₘ, organized in accordance with the following rule: S^{T}ₘ=H\mathring{×}Y′ₙ^{T}, where
Y′ₙ^{T}—a transposed vector-row Y′ₙ,
H—a m×n check matrix of operations, produced by an additional matrix transposition, adding m×m matrix with operations g⁰ at its diagonal and operations g¹ at other positions to this matrix from the right and rearranging columns (identically to rearranging columns of an generating matrix of operations), if rows of an additional matrix correspond to sequences of operations g¹ and g⁰, or in the same way with changing operations g² for operations g⁰, if rows in an additional matrix correspond to sequences of operations g¹ and g².

2. A method for transmitting digital message in accordance with item 1, which differs in changing value of a j-th symbol of a vector-row Y′ₙ by its adding to an element, inverse to one of the elements, not equal e, in vector-column S^{T}ₘ, when vector-column S^{T}ₘ contains identical elements, not equal e, and when vector-column S^{T}ₘ, conversed by changing its said elements for an operation g⁰ and its other elements—for an operation g¹, corresponds to aj-th column of a check matrix of operations H.

3. A method for transmitting digital message in accordance with item 1 or 2, which differs in transforming, when message elements belong to a ring with a unity, an operation g⁰ into an operation of a multiplication into a unity, an operation g¹ into an operation of a multiplication into a zero and an operation g² into an operation of a multiplication into a minus unity.

4. A method for transmitting digital message in accordance with any 1-3 items, which differs in transforming, when message elements belong to a residue class ring to the modulo q, where q is a natural number, an operation (+) into a summing operation to the modulo q.

5. A system for transmitting digital message, consisting of additive Abelian group elements, comprises serially connected at a transmitting side an encoder with an input forming a system input, a modulator and a transmitter and serially connected at a receiving side a demodulator and a decoder with an output forming a system output for a non-correctable message, and differs in producing encoder in a form, permitting to realize an algorithm: Yₙ=Xₖ\mathring{×}G, where
Xₖ—a vector-row of an initial message, consisting of k information elements,
Yₙ—a vector-row of an encoded message, consisting of k information and m check elements, m—the smallest integer not less, than log₂ n, n=k+m,
G—a generating matrix of operations which consists of k rows and n columns, produced with a help of a k×k matrix, with operations g⁰ at a diagonal and operations g¹ at other positions, and with a help of an additional k×m matrix, which is added to a k×k matrix from the right and non-repeated rows of which are sequences of operations g¹ and g⁰ or operations g¹ and g², chosen from any possible sequences, including not more than (m-2) operations g¹, or a matrix, determined with a help of an above-mentioned generating matrix of operations by rearranging rows and/or columns,
\mathring{×}—an operation of generalized matrix multiplication in accordance with a rule: yⱼ=^{\mathring{+}}Σg^{v}ᵢⱼ(xᵢ) for j≦k, yⱼ=g²[^{\mathring{+}}Σ g^{v}ᵢⱼ(xᵢ)] for j>k, if rows in an additional matrix corresponds to sequences of operations g¹ and g⁰, or in accordance with a rule: yⱼ=^{\mathring{+}}Σg^{v}ᵢⱼ(xᵢ), ef rows in an additional matrix corresponds to sequences of operations g¹ and g², where
yⱼ—a j-th element of a vector-row for an encoded message,
^{\mathring{+}}Σ g^{v}ᵢⱼ(xᵢ)=g^{v}₁ⱼ(xᵢ)\mathring{+}g^{v}₂ⱼ(x₂)\mathring{+} . . . \mathring{+}g^{v}ₖⱼ(xₖ),
\mathring{×}—an operation for summing elements in an Abelian group,
g^{v}ᵢⱼ(xᵢ)—an operation g^{v} for an element xᵢ in accordance with a rule for a ij-th matrix element,
v=[0, 2], i=[1, k], j=[1, n],
g⁰=xᵢ\mathring{+}e, g¹=xᵢ\mathring{+}(−xᵢ), g²=xᵢ\mathring{+}(−xᵢ)\mathring{+}(−xᵢ),
e—a unity element of an Abelian group,
and in producing a decoder in a form, permitting to exclude from a vector-row Y′ₙ elements, corresponding by their numbers to columns of a check matrix of operations H with one operation g⁰, provided there is not more than one element, not equal e, in a vector-column S^{T}ₘ, formed in accordance with a rule: S^{T}ₘ=H\mathring{×}Y′ₙ^{T}, where
Y′ₙ^{T}—a transposed vector-row Y′ₙ,
H—a m×n check matrix of operations, produced by an additional matrix transposition, adding m×m matrix with operations g⁰ at its diagonal and operations g¹ at other positions to this matrix from the right and rearranging columns (identically to rearranging columns of an generating matrix of operations), if rows of an additional matrix corresponds to sequences of operations g⁰ and g¹, or in the same way with changing operations g² for operations g⁰, if rows in an additional matrix correspond to sequences of operations g¹ and g².

6. A system for transmitting digital message in accordance with item 5, which differs in producing decoder in a form, providing correction, before excluding from a vector-row Y′ₙ elements, corresponding by their numbers to columns of a check matrix of operations H, when a vector-column S^{T}ₘ contains identical elements, not equal e, and when a vector-column S^{T}ₘ, conversed by changing its said elements for an operation g⁰ and its other elements—for an operation g¹, corresponds to a j-th column of a matrix H, of a value for a j-th symbol of a vector-row Y′ₙ by adding it to an element, inverse to one of the elements, not equal e, in a vector-column S^{T}ₘ.

7. A system for transmitting digital message in accordance with item 5 or 6, which differs in providing an encoder with the first operative memory unit with k outputs connected to corresponding first k information inputs of the second operative memory unit, an output of which forms an encoder output, the memory unit, used for storing operation codes of an generating matrix of operations, the first group of m calculation units, used for determining check element, with calculation algorithm control inputs connected to m corresponding outputs of the memory unit, used for storing operation codes of an generating matrix of operations, m calculation units, used for calculating function g² and connected between corresponding outputs of the first group of m calculation units, used for determining check element, and corresponding information inputs, from (k+1)-th to n-th, of the second operative memory unit, serially connected the first pulse shape forming unit and the first ring counter, used for counting up to k, with an information input connected to a matrix row address input of the memory unit, used for storing operation codes of an generating matrix of operations, and with an overflow output connected to reset inputs of the first operative memory unit and the first group of m calculation units, used for determining check element, serially connected the pulse generator with a repetition frequency of fn/k, the first switch and the first ring counter, used for counting up to n, with an information output connected to an address input of the second operative memory unit, the first gate AND with an output connected to a control input of the first switch, the first flip-flop with an output connected to a direct input of the first gate AND, an inverting input of which is connected with an overflow output of the first ring counter, used for counting up to n, and to a reset input of the first flip-flop, serially connected the first pulse repetition frequency doubling unit with an input connected to an output of the pulse generator, having a repetition frequency of fn/k, and the ring counter, used for counting up to (2k+1), with an overflow output connected to a counting input of the first flip-flop, combined inputs of the first operative memory unit and of calculation units, used for determining check element, of the first group, consisting of m such calculation units, a start input of the pulse shape forming unit and a synchronization input of the pulse generator with a repetition frequency of fn/k form an encoder input and f corresponds to a repetition frequency for a digital message elements.

8. A system for transmitting digital message in accordance with any of 5-7 items, which differs in providing a decoder with the third operative memory unit with n outputs connected to m corresponding information inputs of the fourth operative memory unit, an output of which forms an encoder output for a non-correctable message, the memory unit, used for storing operation codes of an generating matrix of operations, the second group of m calculation units, used for determining check element, with calculation algorithm control inputs connected to m corresponding outputs of the memory unit, used for storing operation codes of an generating matrix of operations, serially connected the second pulse shape forming unit and the second ring counter, used for counting up to n, with an information input connected to an address input of the memory unit, used for storing operation codes of an generating matrix of operations, and with an overflow output connected to reset inputs of the third operative memory unit and calculation units, used for determining check element, of the second group, consisting of m such calculation units, serially connected the pulse generator with a repetition frequency of fk/n, the second switch, the second ring counter, used for counting up to k, and the third switch with an information output connected to an address input of the fourth operative memory unit, the unit for making decisions on decoding with m inputs connected to outputs of corresponding calculation units, used for determining check element and belonging to the second group consisting m of such calculation units, and with its output connected to a control input of the third switch, the second gate AND with an output connected to a control input of the second switch, the second flip-flop with an output connected to a direct input of the second gate AND, an inverting input of which is connected to an overflow output of the second ring counter, used for counting up to k, and to a reset input of the second flip-flop, serially connected the second pulse repetition frequency doubling unit with an input connected to an output of the pulse generator with a repetition frequency of fk/n, and the ring counter, used for counting up to [2(k+1)+1], with an overflow output connected to a counting input of the second flip-flop, combined inputs of the third operative memory unit and of calculation units, used for determining check element, of the second group, consisting of m such calculation units, a start input of the second pulse shape forming unit and a synchronization input of the pulse generator with a repetition frequency of fk/n form a decoder input.

9. A system for transmitting digital message in accordance with item 8, which differs in connecting an output of the unit for making decisions on decoding to a control input of the third switch through the first gate OR and in providing unit for making decisions on correcting errors with an output connected to a second input of the first gate OR, serially connected the error calculation unit with a start input connected to an output of the unit for making decisions on correcting errors and with a writing input connected to an overflow output of the second ring counter, used for counting up to k, the calculation unit for calculating function g² and the adder for summing Abelian group elements with a second input connected to an output of the fourth operative memory unit and with an output forming an output of a decoder output for a correctable message, m inputs of the unit for making decisions on correcting errors and m inputs of the calculation unit for calculating error are connected to outputs of corresponding calculation units, used for determining check element, of the second group, consisting of m such calculation units.

10. A system for transmitting digital message in accordance with any of 7-9 items, which differs in providing the calculation unit, used for determining check element, with serially connected the fourth switch, the calculation unit for calculating function g¹, the second gate OR, the accumulating adder, used for accumulating Abelian group elements, with an output connected to its second input and the fifth switch with a control input formed as a reset input and with an output formed as an output of the calculation unit, used for determining check element, the sixth switch with an output connected to a second input of the first gate OR, the decipher with an input formed as a calculation algorithm control input of the calculation unit, used for determining check element, and with outputs connected, correspondingly, to control inputs of the sixth and fourth switches, combined information inputs of which form an information input of the calculation unit, used for determining check element.
